(19) United States
(12) Patent Application Publication
(10) Pub. No.: US 2006/0099987 A1
(43) Pub. Date: May 11, 2006

(54) System and method of providing data fill application to support large-scale configuration changes

(75) Inventors: Lakhbir Singh, Herndon, VA (US); Lisa Lutz, Lee, IL (US)

Correspondence Address: CROWELL & MORING LLP;INTELLECTUAL PROPERTY GROUP, P.O. BOX 14300, WASHINGTON, DC, 20044-4300, US

(73) Assignee: Nextel Communications, Inc.

(21) Appl. No.: 10/982,059

(22) Filed: Nov. 5, 2004

(51) Int. Cl. H04M 1/00

(52) U.S. Cl. 455/550.1

(57) ABSTRACT

A wireless communication system is disclosed, comprising a network; a plurality of base stations coupled to the network; and an operations and management center comprising a network interface coupled to the network, and a processor to: generate a new frequency plan for the plurality of base stations; compare the new frequency plan with a current frequency plan; determine which parameters of which base stations of the plurality of base stations require modification; and create and send a new configuration file incorporating the new frequency plan to the base stations whose parameters require modification in order to modify the parameters, wherein the new configuration file is sent to the base stations by way of the network interface.

### FIELD OF THE INVENTION

This invention relates generally to wireless communication systems, and in particular, to a system and method of providing data fill application to support large scale configuration changes in a wireless communication system.

### BACKGROUND OF THE INVENTION

Wireless communication systems have been extremely popular for more than a decade. They allow users to communicate with each other while remaining geographically mobile. In addition, these systems allow communications to be in different modes, such as full-duplex voice, half-duplex voice, data, instant messaging, call alert, to illustrate some examples.

A typical wireless communication system consists of a network including a plurality of base stations (e.g., an Enhanced Base Transceiver Station (EBTS)), call processing devices (e.g., a dispatch application processor (DAP) or base station controller (BSC)), voice processing devices (e.g., a packet duplicator (PD)), and provisioning devices (e.g., a home location register (HLR)), to name a few. In addition to these devices, a wireless communication system includes an operations and management center (OMC) to set and control the various configuration parameters of these and other network devices.

As a specific example, the OMC is used to set and control the radio frequency (RF) parameters of the base stations of a wireless communication system. For instance, the OMC sets and controls such base station parameters as the carrier number, frequency, transmit power, color code, among other parameters. More specifically, the carrier number is a set of transmit and receive frequencies separated by a fixed frequency (e.g., 45 KHz), wherein each carrier is assigned a unique number (e.g., 1 to 1199). The frequency can be the transmit carrier frequency or the receive carrier frequency. The transmit power specifies the power in which the base station transmits its carrier. The color code in combination with the carrier number helps in uniquely identifying a base station, wherein the color code is specified within a range of numbers (e.g., 0 to 15).

In the past, the base stations parameters were typically arrived at manually by a frequency planner using a spreadsheet to play with the parameters to arrive at a set of base station parameters that optimizes the overall RF environment for subscribers. Once the new set of base station parameters, typically referred to as the new frequency plan, were determined, an operator manually enters the data into the OMC. The OMC uses the entered data to create and send a new configuration file to the base stations in order to modify the required parameters.

The manual entry of the data into the OMC, however, is typically very labor intensive and can take up a substantial amount of time to complete. For example, the manual entry of a new frequency plan data into the OMC can take any where from three to five days. During such period, all other configuration changes need to be put on hold.

### SUMMARY OF THE INVENTION

An aspect of the invention relates to a wireless communication system, comprising a network; a plurality of base stations coupled to the network; and an operations and management center comprising a network interface coupled to the network, and a processor to: generate a new frequency plan for the plurality of base stations; compare the new frequency plan with a current frequency plan; determine which parameters of which base stations of the plurality of base stations require modification; and create and send a new configuration file incorporating the new frequency plan to the base stations whose parameters require modification in order to modify the parameters, wherein the new configuration file is sent to the base stations by way of the network interface.

Another aspect of the invention relates an operations and management center to set configuration parameters of a plurality of base stations coupled to a network, comprising a network interface coupled to the network, and a processor to generate a new frequency plan for the plurality of base stations; compare the new frequency plan with a current frequency plan; determine which parameters of which base stations of the plurality of base stations require modification; and create and send a new configuration file incorporating the new frequency plan to the base stations whose parameters require modification in order to modify the parameters, wherein the new configuration file is sent to the base stations by way of the network interface. A method and software modules related to the operation of the operations and management center are also disclosed.

Still another aspect of the invention relates to a wireless communication system, comprising a network; a plurality of base stations coupled to the network; and an operations and management center comprising a network interface coupled to the network, and a processor to: receive an electronic file of a new frequency plan for the plurality of base stations; compare the new frequency plan with a current frequency plan; determine which parameters of which base stations of the plurality of base stations require modification; and create and send a new configuration file incorporating the new frequency plan to the base stations whose parameters require modification in order to modify the parameters, wherein the new configuration file is sent to the base stations by way of the network interface.

Yet another aspect of the invention relates to an operations and management center to set configuration parameters of a plurality of base stations coupled to a network, comprising a network interface coupled to the network, and a processor to: receive an electronic file of a new frequency plan for the plurality of base stations; compare the new frequency plan with a current frequency plan; determine which parameters of which base stations of the plurality of base stations require modification; and create and send a new configuration file to the base stations whose parameters require modification in order to modify the parameters, wherein the new configuration file is sent to the base stations by way of the network interface. A method and software modules related to the operation of the operations and management center are also disclosed.

Other aspects, features, and techniques of the invention will be apparent to one skilled in the relevant art in view of the following detailed description of the invention.

### BRIEF DESCRIPTION OF THE DRAWINGS

FIG. 1 illustrates a block diagram of an exemplary wireless communication system in accordance with an aspect of the invention;

FIG. 2 illustrates a block diagram of an exemplary operations and management center (OMC) in accordance with another aspect of the invention;

FIG. 3 illustrates a flow chart of an exemplary method implemented by the OMC in accordance with another aspect of the invention;

FIG. 4A illustrates a table of an exemplary current frequency plan in accordance with another aspect of the invention;

FIG. 4B illustrates a table of an exemplary new frequency plan in accordance with another aspect of the invention; and

FIG. 5 illustrates a flow chart of another exemplary method implemented by the OMC in accordance with aspect of the invention.

### DETAILED DESCRIPTION OF THE PREFERRED EMBODIMENTS

FIG. 1 illustrates a block diagram of an exemplary wireless communication system 100 in accordance with an aspect of the invention. The wireless communication system 100 comprises a network 102, a plurality of base stations 104, 106, and 108, an operations and management center (OMC) 110, and optionally a dedicated frequency planning tool 112. The wireless communication system 100 provides communication services to a plurality of subscriber units (SUs) 114, 116, 118, 120, and 122.

The network 102 communicatively couples together a plurality of network devices, such as the OMC 110, the base stations 104, 106, and 108, and possibly the frequency planning tool 112. It shall be understood that other network devices may be coupled to the network 102, including call processing devices (e.g., a dispatch application processor (DAP) or base station controller (BSC)), voice processing devices (e.g. a packet duplicator (PD)), and provisioning devices (e.g. a home location register (HLR)), to name a few. The network 102 may be compliant with various protocols, such as Internet Protocol (IP), asynchronous transfer mode (ATM), frame relay, or other standard or proprietary protocol.

The base stations 102, 104, and 106 provide a wireless interface between the SUs 114, 116, 118, 120, and 122 and the network 102. The base stations may each include one or more sectors. In this example, each of the base stations 104, 106, and 108 include three sectors numbered 1-3. Each sector is associated with various configuration parameters, such as the carrier number, carrier frequency, transmit power, color code, and other parameters. Although only three base stations are shown in the exemplary wireless communication system 100, it shall be understood that the wireless communication system 100 may include hundreds or thousands of base stations.

The SUs 114, 116, 118, 120, and 122 can be any portable or generally stationary devices that communicate with the base stations 104, 106, and 108 via a wireless medium. The SUs, for example, can be cellular and/or dispatch handsets, personal digital assistants (PDAs), laptop computers, desktop computers, pagers, etc. In this example, SU 114 is communicating with sector 3 of base station 104, SU 116 is communicating with sector 2 of base station 104, SU 118 is communicating with sector 2 of base station 106, SU 120 is communicating with sector 3 of base station 108, and SU 122 is communicating with sector 1 of base station 122.

The OMC 110 sets and controls the configuration parameters of the base stations 104, 106, and 108. In this regard, the OMC 110 sends a new configuration file to the base stations 104, 106, and 108 by way of the network 102 to set and control the configuration parameters of the base stations. The OMC 110 may include a frequency planning software tool 112 to assist a frequency planner in developing a new frequency plan for the base stations 104, 106, and 108. The frequency planning software tool 112 may be integrated with the OMC 110, or may be a separate entity as shown.

In operation, when a new frequency plan is desired because of any of a number of reasons (e.g., the RF environment has adversely changed), an operator uses the frequency planning software tool 112 to arrive at a new set of configuration parameters for the base stations (i.e., a new frequency plan). The frequency planning software tool 112 generates a file containing the information regarding the new frequency plan. The OMC 110 then compares the new frequency plan with the current frequency plan to determine which parameters of which base stations require modification. Once the OMC 110 determines which parameters of which base stations need to be modified according to the new frequency plan, it creates and sends a new configuration file incorporating the new frequency plan to those base stations by way of the network 102 in order to cause those parameters to be modified. The OMC 110 saves the new frequency plan as the current frequency plan.

An advantage of this system and method over what has been done in the past is that the updating of the configuration parameters of the base stations can be completed in a few minutes as oppose to three to five days. This substantially reduces the amount of labor required to perform the configuration update. In the long run, this system and method will save service providers a substantial amount in costs associated with performing configuration changes on their respective wireless communication systems. Furthermore, the relatively speedy configuration update provided by this system and method will not put other network configuration update on hold for a relatively long time.

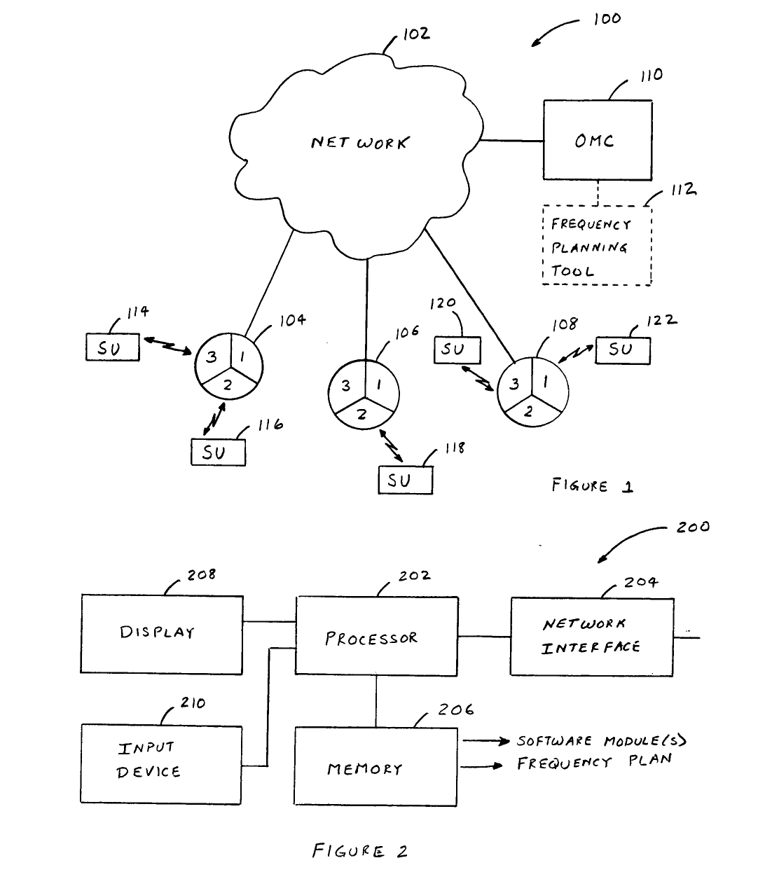

FIG. 2 illustrates a block diagram of an exemplary operations and management center (OMC) 200 in accordance with another aspect of the invention. The OMC 200 may be an exemplary detailed version of the OMC 110 of wireless communication system 100. The OMC 200 comprises a processor 202, a network interface 204, a memory 206, a display 208, and an input device 210 (e.g., a keyboard and pointing device).

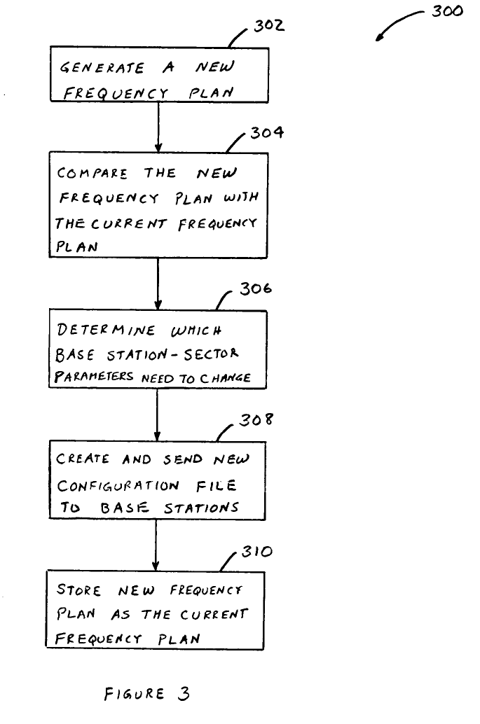

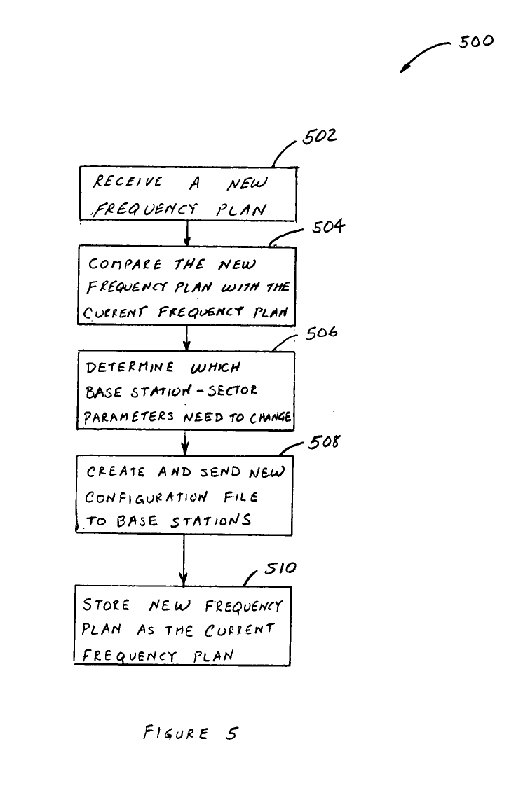

The processor 202 performs the various operations of the OMC 200 including the operations of the methods discussed with reference to FIGS. 3 and 5. The network interface 204 provides the OMC 200 with an interface to the network 102 to receive communications from and transmit communications to various network devices, including the base stations 104, 106, and 108. The memory 206, serving generally as a computer readable medium, stores one or more software modules that control the processor 202 in performing its various operations. The memory 206 may also store information related to the new and current frequency plans, as discussed below.

The display 208 provides visual information to an operator, such as information relating to the current and new frequency plans, and/or the configuration parameters that need to be modified in accordance with the new frequency plan. The input device 210 allows an operator to cause the processor 202 to generate a new frequency plan, to cause the processor 202 to compare the new frequency plan with the current frequency plan, and to cause the processor 202 to create and send a new configuration file incorporating the new frequency plan to the base stations that require parameter modification in accordance with the new frequency plan. It shall be understood that the display 208 and the input device 210 may be an integrated unit, such as a touch-sensitive screen.

FIG. 3 illustrates a flow chart of an exemplary method 300 implemented by the OMC 200 in accordance with another aspect of the invention. The OMC 200 implements method 300 in the case that the frequency planning software tool is integrated with the operations and maintenance software tool. According to the method 300, the processor 202 generates a new frequency plan in response to inputs received by an operator using the input device 210 (block 302). Once the new frequency plan is complete, the processor 202 compares the new frequency plan with the current frequency plan (block 304).

Based on the comparison, the processor 202 determines which configuration parameters of which base stations require modification in accordance with the new frequency plan (block 306). After the processor 202 makes such determination, it creates and sends a new configuration file incorporating the new frequency plan to such base stations by way of the network interface 204 (block 308). Once this occurs, the processor 202 stores the new frequency plan file as the current frequency plan file in memory 206 (block 310).

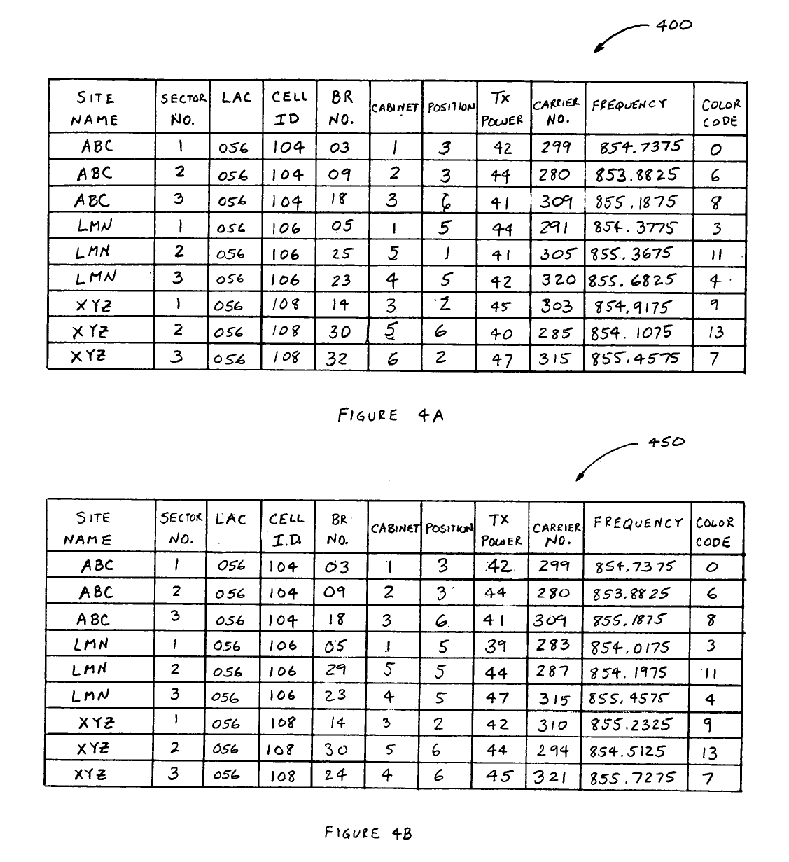

FIG. 4A illustrates a table of an exemplary current frequency plan 400 in accordance with another aspect of the invention. As discussed, the frequency plan 400 keeps track of various information relating to base stations and their respective configuration parameters. Such information include the Base Station (i.e. Site) Name, Sector Number, Location Area Code (LAC), Base Station (i.e. Cell) identification number, Base Radio (BR) Number, Cabinet, Position, Transmitter (Tx) Power, Carrier Number, Frequency, and Color Code.

A service provider may provide a unique name (i.e., Base Station Name) for each of its base stations for identification purposes. For example, the base station 104 has been given the name of ABC, base station 106 has been given the name of LMN, and base station 108 has been given the name of XYZ. The Sector Number identifies the sector of the corresponding base station. For example, a cell site may have one or more sectors (e.g. three sectors), which are directional antennas and associated radios used to provide coverage to respective geographical areas. The LAC is a pool of base stations managed by the wireless communication system for paging and keeping track of the location of SUs. In this example, the pool of base stations 104, 106, and 108 are assigned to provide coverage to LAC 056.

The Base Station (i.e. Cell) identification number is used to identify a base station within a location area. The combination of the LAC and the Base Station ID uniquely identifies a base station within the wireless communication system. The Base Radio (BR) identifies the radio used for transmitting and receiving. A base station can have a number of base radios. For example, a base station 20 can have up to 36 base radios with 20 base radio limit per sector. The Cabinet identifies the cabinet in which the current radio resides. For example, a cabinet may house up to six base radio. The Position is used to define the position of the current base radio in a cabinet.

The Tx Power specifies the power level in which the current base radio is transmitting. The Carrier Number identifies a set of transmit and receive frequencies separated by a fixed frequency delta (e.g., 45 KHz), wherein each carrier is assigned a unique number (e.g., 1-1199, valid for a 800 MHz band). The Frequency is the carrier frequency in MHz of the transmitter or receiver. A Color Code (e.g., range from 0-15) is assigned to each base station to assist in identifying base stations.

FIG. 4B illustrates a table of an exemplary new frequency plan 450 in accordance with another aspect of the invention. As the new frequency plan 450 indicates, various configuration parameters for base stations 106 and 108 have changed from what they were according to the old frequency plan 400. For instance, the Tx Power, Carrier Number, and Frequency parameters for sectors 1-3 of base stations 106 and 108 have changed. In addition, the base radio for sector 2 of base station 106 has changed, which is in a different position (i.e., position 5 as oppose to position 1) in cabinet no. 5. Furthermore, the base radio for sector 3 of base station 108 has changed, which is in a different position (i.e. position 6 as oppose to position 2) in a different cabinet (i.e., cabinet no. 4 as oppose to cabinet no. 6).

As discussed above with reference to FIG. 3 and also below with reference to FIG. 5, the OMC 200 determines such parameters that require changing by comparing the new frequency plan 450 with the old frequency plan 400. Once the comparison is complete, the OMC 200 creates and sends a new configuration file incorporating the new frequency plan 450 to base stations 106 and 108 by way of the network 102 in order to modify such parameters consistent with the new frequency plan 450.

FIG. 5 illustrates a flow chart of an exemplary method 500 implemented by the OMC 200 in accordance with another aspect of the invention. The OMC 200 implements method 500 in the case that the frequency planning software tool is implemented in a separate computing device. According to the method 500, the processor 202 receives a new frequency plan file by way of the network interface 204 or other interface in response to a request received from the operator using the input device 210 (block 502). Once the new frequency plan file is received, the processor 202 compares the new frequency plan with the current frequency plan (block 504).

Based on the comparison, the processor 202 determines which configuration parameters of which base stations require modification in accordance with the new frequency plan (block 506). After the processor 202 makes such determination, it creates and sends a new configuration file to such base stations by way of the network interface 204 (block 508). Once this occurs, the processor 202 stores the new frequency plan file as the current frequency plan file in memory 206 (block 510).

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

It is claimed:

1. A wireless communication system, comprising:
a network;
a plurality of base stations coupled to said network; and
an operations and management center comprising:
a network interface coupled to said network;
a processor to:
generate a new frequency plan for said plurality of base stations;
compare said new frequency plan with a current frequency plan;
determine which parameters of which base stations of said plurality of base stations require modification; and
create and send a new configuration file incorporating said new frequency plan to said base stations whose parameters require modification in order to modify said parameters, wherein said new configuration file is sent to said base stations by way of said network interface and said network.

2. The wireless communication system of claim 1, wherein said operations and management center further comprises a computer readable medium including one or more software modules to control said processor in performing said stated operations.

3. The wireless communication system of claim 1, wherein said parameter comprises at least one of the following parameters:
a transmit carrier frequency;
a receive carrier frequency;
a carrier number;
a transmit power level; and
a color code that is associated with the corresponding base station.

4. The wireless communication system of claim 1, wherein said operations and management center further comprises a display to provide a user visual information of said new frequency plan, said current frequency plan, said base stations that require modification of at least one of their respective parameters, and said parameters that require modification.

5. The wireless communication system of claim 1, wherein said operations and management center further comprises an input device to allow a user to control said processor in performing said stated operations.

6. An operations and management center to set configuration parameters of a plurality of base stations coupled to a network, comprising:
a network interface coupled to said network;
a processor to:
generate a new frequency plan for said plurality of base stations;
compare said new frequency plan with a current frequency plan;
determine which parameters of which base stations of said plurality of base stations require modification; and
create and send a new configuration file incorporating said new configuration file to said base stations whose parameters require modification in order to modify said parameters, wherein said new configuration file is sent to said base stations by way of said network interface.

7. The operations and management center of claim 6, further comprising a computer readable medium including one or more software modules to control said processor in performing said stated operations.

8. The operations and management center of claim 6, wherein said parameter comprises at least one of the following parameters:
a transmit carrier frequency;
a receive carrier frequency;
a carrier number;
a transmit power level; and
a color code that is associated with the corresponding base station.

9. The operations and management center of claim 6, further comprising a display to provide a user visual information of said new frequency plan, said current frequency plan, said base stations that require modification of at least one of their respective parameters, and said parameters that require modification.

10. The operations and management center of claim 6, further comprising an input device to allow a user to control said processor in performing said stated operations.

11. A computer readable medium comprising one or more software modules to control a processor to:
generate a new frequency plan for a plurality of base stations;
compare said new frequency plan with a current frequency plan;
determine which parameters of which base stations of said plurality of base stations require modification; and
create and send a new configuration file incorporating said new frequency plan to said base stations whose parameters require modification in order to modify said parameters.

12. The computer readable medium of claim 11, wherein said parameters comprise at least one of the following parameters:
a transmit carrier frequency;
a receive carrier frequency;
a carrier number;
a transmit power level; and
a color code that is associated with the corresponding base station.

13. A method of setting configuration parameters of a plurality of base stations, comprising:
generating a new frequency plan for said plurality of base stations;
comparing said new frequency plan with a current frequency plan;
determining which parameters of which base stations of said plurality of base stations require modification; and
creating and sending a new configuration file incorporating said new frequency plan to said base stations whose parameters require modification in order to modify said parameters.

14. The method of claim 13, wherein said parameters comprise at least one of the following parameters:
a transmit carrier frequency;
a receive carrier frequency;
a carrier number;
a transmit power level; and
a color code that is associated with the corresponding base station.

15. The method of claim 13, further comprising providing visual information to a user of said new frequency plan, said current frequency plan, said base stations that require modification of at least one of their respective parameters, and said parameters that require modification.

16. The method of claim 13, further comprising receiving inputs from a user to control said generating, comparing, determining and transmitting operations.

17. A wireless communication system, comprising:
a network;
a plurality of base stations coupled to said network; and
an operations and management center comprising:
a network interface coupled to said network;
a processor to:
receive an electronic file of a new frequency plan for said plurality of base stations;
compare said new frequency plan with a current frequency plan;
determine which parameters of which base stations of said plurality of base stations require modification; and
create and send a new configuration file incorporating said new frequency plan to said base stations whose parameters require modification in order to modify said parameters, wherein said new configuration file is sent to said base stations by way of said network interface and said network.

18. The wireless communication system of claim 17, wherein said operations and management center further comprises a computer readable medium including one or more software modules to control said processor in performing said stated operations.

19. The wireless communication system of claim 17, wherein said parameter comprises at least one of the following parameters:
a transmit carrier frequency;
a receive carrier frequency;
a carrier number;
a transmit power level; and
a color code that is associated with the corresponding base station.

20. The wireless communication system of claim 17, wherein said operations and management center further comprises a display to provide a user visual information of said new frequency plan, said current frequency plan, said base stations that require modification of at least one of their respective parameters, and said parameters that require modification.

21. The wireless communication system of claim 17, wherein said operations and management center further comprises an input device to allow a user to control said processor in performing said stated operations.

22. An operations and management center to set configuration parameters of a plurality of base stations coupled to a network, comprising:
a network interface coupled to said network;
a processor to:
receive an electronic file of a new frequency plan for said plurality of base stations;
compare said new frequency plan with a current frequency plan;
determine which parameters of which base stations of said plurality of base stations require modification; and
create and send a new configuration file incorporating said new frequency plan to said base stations whose parameters require modification in order to modify said parameters, wherein said new configuration file is sent to said base stations by way of said network interface.

23. The operations and management center of claim 22, further comprising a computer readable medium including one or more software modules to control said processor in performing said stated operations.

24. The operations and management center of claim 22, wherein said parameter comprises at least one of the following parameters:
a transmit carrier frequency;
a receive carrier frequency;
a carrier number;
a transmit power level; and
a color code that is associated with the corresponding base station.

25. The operations and management center of claim 22, further comprising a display to provide a user visual information of said new frequency plan, said current frequency plan, said base stations that require modification of at least one of their respective parameters, and said parameters that require modification.

26. The operations and management center of claim 22, further comprising an input device to allow a user to control said processor in performing said stated operations.

27. A computer readable medium comprising one or more software modules to control a processor to:
receive an electronic file of a new frequency plan for said plurality of base stations;
compare said new frequency plan with a current frequency plan;
determine which parameters of which base stations of said plurality of base stations require modification; and
create and send a new configuration file incorporating said new frequency plan to said base stations whose parameters require modification in order to modify said parameters.

28. The computer readable medium of claim 27, wherein said parameters comprise at least one of the following parameters:
a transmit carrier frequency;
a receive carrier frequency;
a carrier number;
a transmit power level; and
a color code that is associated with the corresponding base station.

29. A method of setting configuration parameters of a plurality of base stations, comprising:
receiving an electronic file of a new frequency plan for said plurality of base stations;
comparing said new frequency plan with a current frequency plan;
determining which parameters of which base stations of said plurality of base stations require modification; and
creating and sending a new configuration file incorporating said new frequency plan to said base stations whose parameters require modification in order to modify said parameters.

30. The method of claim 29, wherein said parameters comprises at least one of the following parameters:
a transmit carrier frequency;
a receive carrier frequency;
a carrier number;
a transmit power level; and
a color code that is associated with the corresponding base station.

31. The method of claim 29, further comprising providing visual information to a user of said new frequency plan, said current frequency plan, said base stations that require modification of at least one of their respective parameters, and said parameters that require modification.

32. The method of claim 29, further comprising receiving inputs from a user to control said receiving, comparing, determining and transmitting operations.
